(19) United States
(12) Patent Application Publication
(10) Pub. No.: US 2011/0055906 A1
(43) Pub. Date: Mar. 3, 2011

(54) METHOD FOR AUTHENTICATION AND VERIFYING INDIVIDUALS AND UNITS

(75) Inventors: Werner Rozek, Floh-Seligenthal (DE); Thomas Rozek, Floh-Seligenthal (DE); Jan Rozek, Floh-Seligenthal (DE)

(73) Assignee: FACHHOCHSCHULE SCHMALKALDEN, Schmalkalden (DE)

(21) Appl. No.: 12/918,539

(22) PCT Filed: Nov. 17, 2008
(86) PCT No.: PCT/EP08/65646

§ 371 Date: Nov. 11, 2010

(30) Foreign Application Priority Data
Feb. 22, 2008 (DE) 10 2008 010 788.3

(51) Int. Cl. G06F 21/00; H04L 9/32

(52) U.S. Cl. 726/4

(57) ABSTRACT

A method is provided for authenticating and verifying individuals and units, wherein the data exchange between the units proceeds by means of relative data and/or encrypted data. The method is characterized in that the authentication and/or verification processes of individual and/or units are carried out by units that are allocated to individuals or that the authentication and/or verification processes of individuals and/or units are carried out by units authorized to authenticate and/or verify, a unit being authorized to authenticate and/or verify by the transmission of at least one copy of a power by a unit allocated to an individual through the unit allocated to the individual once the owner of the unit allocated to an individual is authenticated.

The present invention relates to a method for authentication and authentification of persons and/or devices. Both terms, “authentication” and “authentification”, provide information about the trustworthiness of the sender and the recipient. The term “authentication” herein is to refer to a verification of authenticity of the sender by the sender himself, and of the recipient by the recipient himself. The term “authentification” herein is to refer to a verification of authenticity of the sender by the recipient, and of the recipient by the sender.

Technical solutions for authentication are known that use biometrical characteristics. For example, biometrical characteristics such as fingerprints, iris data, and the like can be used. By checking inputted biometrical characteristics against stored biometrical characteristics, a party is authenticated. Additionally, passwords can be used for authentication.

Authentification is based on knowledge and on possession. Digital signatures, key dependent hash functions can be used for authentification. When using key dependent hash functions, each protocol message has to include a key dependent hash value. A disadvantage of this solution is in the exchange of keys.

EP 1 845 655 A1 discloses a signature method that ensures the identity of the data signing person by any signature. According to legislation regarding signature, there is a variety of signature terms. The term D(m)=sig is referred to as an electronic (or digital) signature (sig). D indicates a private key, and m indicates a signed message. In conjunction with a signature scheme, a public key E can be used to verify, if a message m is in conformance with the signature (sig). Advanced electronic signature refers to digital signature. Qualified signature is based on qualified certificates. Signature key certificates, e.g. according to X.509, comprise the name or pseudonym of the key proprietor, the public signature key assigned to the signature key proprietor, the sequential number of the certificate, start and end time of validity of the certificate, and the name of the certifying authority. The signing person enters a personal authentification token, generates a hash value from the data to be signed using a signature unit, and determines the signature for the data to be signed from the hash value and from authentification information which unambiguously identify the identity of the signing person.

DE 60 2005 000 121 T2 describes a method and an apparatus for reducing spam e-mail as well as the distribution of viruses by authenticating the origin of e-mail messages. The e-mail standard RFC 2821 allows verification of the sender of an e-mail. In this verification, only the existence of the sender's address in the domain is verified. It is not checked, whether the e-mail has really been sent from this address. Features of the method comprise receiving a request at an origin server of the e-mail message, checking data logged at the origin server, and responding to the request by the origin server. The request includes the question whether the user indicated in the e-mail message really is the sender of the e-mail. Logging serves to determine the origin of the transmission. The response to a request serves for authentification of the origin of the e-mail.

An object of the invention is to provide a method in which the identities of the sender and of the recipient of a message cannot be altered by the sender and/or the recipient and/or a third party, even with knowledge of the identities and all of the method steps.

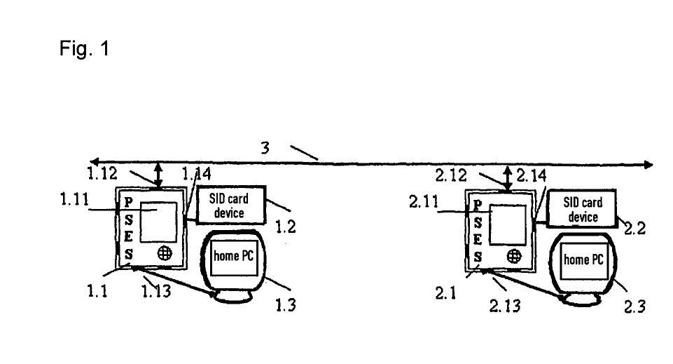

According to the invention, this object is achieved by the teachings set forth in the claims. The invention will now be described in detail with reference to exemplary embodiments that are illustrated in FIGS. 1, 2, 3, and 4.

In the drawings:

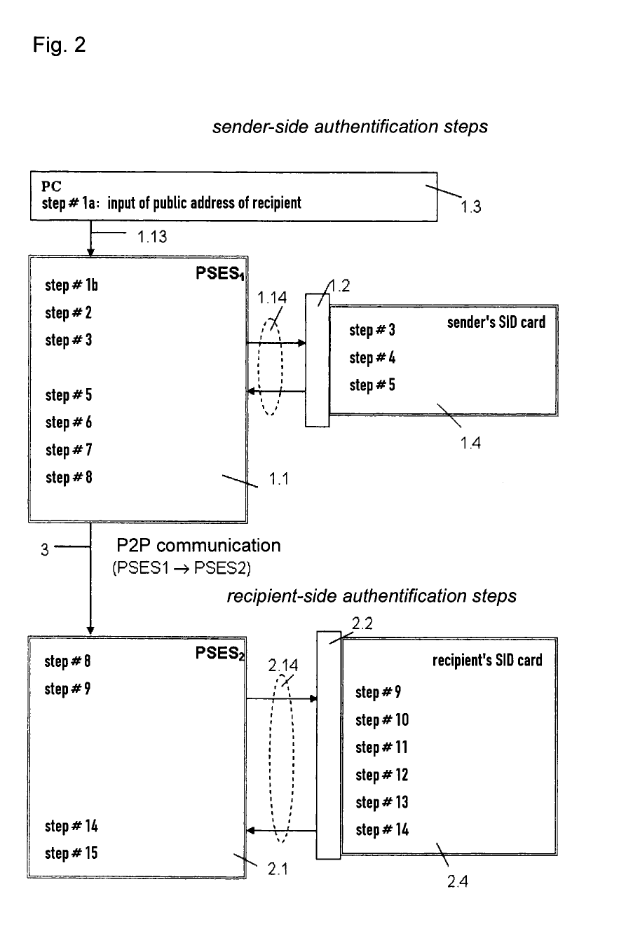

FIG. 2 shows authentification using an SID card;

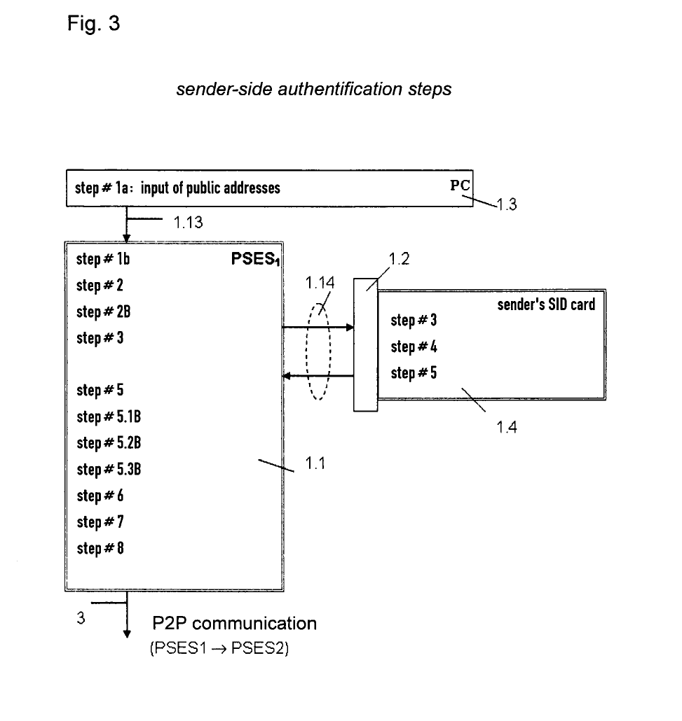

FIG. 3 authentification via SID card authorized PSES;

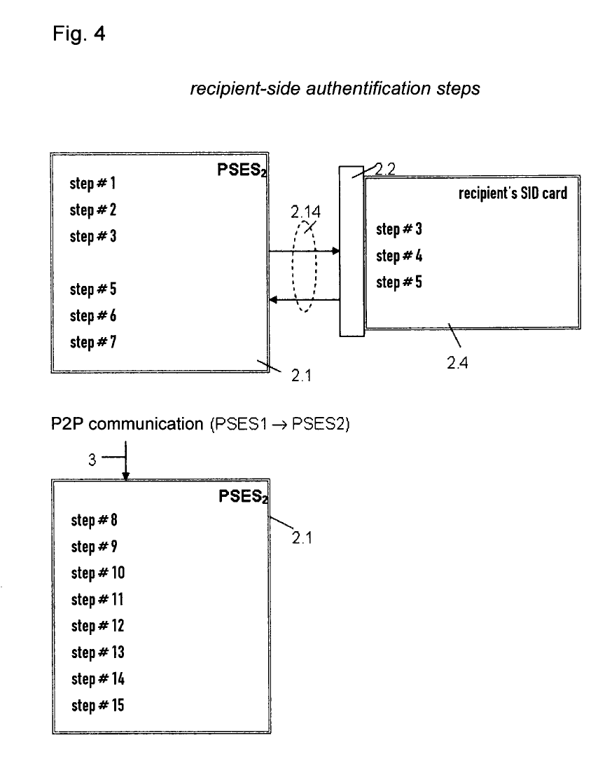

FIG. 4 authentification via SID card authorized PSES.

FIG. 1 shows, on the side of the sender, a unit 1.1, an SID card device 1.2, a home PC 1.3, and on the side of the recipient, a unit 2.1, an SID card device 2.2, and a home PC 2.3. Sender side unit 1.1 is connected to the recipient side unit 2.1 via a communication network 3, e.g. the internet. Units 1.1 and 2.1 are the communication and/or authentification performing units. Units 1.1 and 2.1 each comprise at least one touchscreen, 1.11 and 2.11 respectively, associated with the unit. Unit 1.1 is connected to the internet 3 through an interface 1.12, to SID card device 1.2 through an interface 1.14, and to the home PC through an interface 1.13. Unit 2.1 is connected to the internet 3 through an interface 2.12, to SID card device 2.2 through an interface 2.14, and to the home PC through an interface 2.13. Each person possesses a unit assigned to the person, not illustrated in FIG. 1, which shall also be referred to as a ‘personal unit’ below. The personal unit is a secure identification card (SID card). Any exposure of a person in the cyberspace and any action performed in the cyberspace is only possible in conjunction with the personal unit. It carries at least data identifying the person and assigned to the person associated with the card, data identifying the personal unit, and random reference data. The random reference data are valid for randomly predefined times. The identifying data used for authentication of a person are biometrical data. Preferably, fingerprint data are used. The identifying data used for authentification of a person are data identifying the personal unit (SID card) and/or address data of the person. The address data comprise an address data element and an identity data element of the person. The data identifying the person furthermore comprise at least one signature data element identifying the signature of the person. The data assigned to a person comprise e.g. social insurance number, tax number, account numbers, cards number, commercial register number, association register number, cooperation register number. They also comprise a card validity data element and a data element identifying the certifying authority. The card validity data element comprises the date of certification of the data identifying the person, and a signature data element of the certifying person. Each unit performing authentification and/or communication, and each personal unit includes at least one random reference data element for randomly predefined time intervals, and at least one data element identifying the unit. The data element identifying the unit is inseparably and unalterably combined with the unit, and preferably is a worldwide unique device or card number.

In an instruction process, the card validity data element, the data element identifying the certifying authority, the address data, the signature data element or the signature data, and the biometrical data of the respective person are imported into an SID card and unalterably stored in the SID card. After at least a second pass of importation of all signature data and biometrical data of the same person and comparison of the imported data with the data stored, the personal SID card is enabled. With this activation all data imported during the instruction process are authorized. In another instruction process, the person, after successful authentication of the card possessor by the personal unit, can import the data assigned to himself or herself into his or her SID card, and can store it within his or her SID card in a manner unalterable for a third party. Also, after successful authentication of the card possessor by the personal unit, the person can alter his or her personal data.

The authentication of a card possessor is performed by the personal unit on the basis of biometrical characteristics of the card possessor. In a first embodiment of the SID card, the biometrical characteristics can only be imported indirectly via biometrical sensors, not illustrated, of units 1.1 and 2.1. In a second embodiment of the SID card, the importation process is performed directly on the SID card, via biometrical sensors.

FIG. 2 shows an exemplary embodiment of the first part of the method according to the invention in which authentication and authentification processes are performed using personal SID cards. In this case, the SID cards not only carry the identifying and/or personal data but also function as a device for checking these data.

The figure illustrates communication performing unit 1.1, SID card device 1.2, home PC 1.3, and SID card 1.4 of the sender, and communication performing unit 2.1, SID card device 2.2, and SID card 2.4 of the recipient. The method steps of authentification at the sender's and the recipient's side are briefly described as follows:

### Sender-Side Authentification Steps

Step #1b: Selecting the address of the recipient from address register via PSES touchscreen;

Step #2: Acknowledging the public address via touch button;

Step #3: Communication PSES1→SID card of the sender

Request to provide the sender's address (authorized address and identity);

Step #4: Generating secret address data of the sender with a length of 96 bits from the two address data of the sender having a length of 80 bits each, and at least one 16 bit random data element in conjunction with the bit position data element SODki→interlacing the address data of 2×80 bits with the 16 bit random feature into 2×96 bits of secret address data of the sender;

Step #5:

Preparation of communication:
determining relative data of the sender's address with a length of 128 bits, and the SID control information (including SODki) with reference to card random reference data→generating relative data with a length of 1024 bits→interlacing permutation of the relative data
Communication SID card→PSES1
De-interlacing permutation
→determining the 1024 bits of data from the relative data thereof→therefrom the relative address data with a length of 128 bits→therefrom the address data of the sender with a length of 96 bits;

Step #6: Generating the secret address data of the recipient with a length of 96 bits from the two address data of the recipient having a length of 80 bits each, and at least one 16 bit random data element in conjunction with the bit position data element SODki→interlacing the address data of 2×80 bits with the 16 bit random feature into 2×96 bits of secret address data of the recipient;

Step #7: Determining the relative address data with a length of 128 bits for:

secret sender address gABAki with reference to the random reference data element PZki
secret recipient address gADAki with indirect reference to gABAki
secret sender identity gABIki with indirect reference to gADAki
secret recipient identity gADIki with indirect reference to gABIki;

Step #8: Preparation of communication:

Determining P2P control information (including SODki) with reference to P2P random reference data→arranging all of the 128 bits of relative data in a sequence→generating 1024 bits of relative data with reference to P2P random reference data→interlacing permutation→transmission in a header having a length of N×1024 bits→

P2P communication (PSES1→PSES2)—at the sender's side

### Recipient-Side Authentification Steps

P2P communication (PSES1→PSES2)—at the recipient's side

De-interlacing permutation→determining the 1024 bits of data from the relative data thereof with reference to P2P random reference data→therefrom the relative address data with a length of 128 bits with reference to P2P random reference data→determining the secret address data gABAki, gADAki, gABIki, and gADIki→determining secret address data of the sender and of the recipient with a length of 96 bits;

Step #9:

Preparation of communication:
Determining relative address data with a length of 128 bits, and SID control information (including SODki) with reference to card random reference data→generating 1024 bits of relative data→interlacing permutation→
Communication PSES2→SID card of the recipient
De-interlacing permutation→determining the 1024 bits of data from the relative data thereof with reference to the card random reference data→therefrom the SID control information (including SODki) and the relative address data with a length of 128 bits→therefrom the address data of the recipient and of the sender with a length of 96 bits;

Step #10:

De-interlacing the secret 96 bits of address data of the recipient and the sender from the 16 bits of random features in conjunction with SODki;

Step #11: Comparing the received and the authorized, stored recipient's address data

→no data match→error!

→data match→continue!

Step #12:

Comparing the address random characteristics,
Comparing the identity random characteristics;

Step #13: Match in all comparisons→recipient and sender authenticated!

Step #14: Communication SID card→PSES2

Information about authenticity of the recipient and the sender;

Step #15: Permitting further data reception.

The authentification of a counterpart always starts at the counterpart and with the counterpart. Before transmitting a message, the sender enters the public address data of the recipient at the home PC 1.3, which data are transmitted from home PC 1.3 to unit 1.1 where they are visualized on the touchscreen. Alternatively, the recipient's address data can be inputted directly through the touchscreen of unit 1.1, and/or can be chosen from an address register. The sender of a message checks the recipient's data visualized on the touchscreen, and confirms the correctness of his input and selection, respectively, via a touch button. Following confirmation, unit 1.1 requests the SID card 1.4 of the sender to provide the sender's address (authorized address and identity). The communication between unit 1.1 and SID card 1.4 occurs in form of relative data. SID card 1.4 generates a position data element SODki using its random generator. In conjunction with the position data element SODki, unit 1.4 generates the secret 96 bits of address data from the two address data having a length of 80 bits (authorized sender data element, authorized identity data element) and at least one random data element having a length of 16 bits. The second position data element (SODki) includes two bytes. The first byte indicates the byte position in the valid random reference data element, and the second byte indicates the bit position in the selected byte of the separate random reference data element, from where on the 16 bits of the random data element or the 16 bits of random data and the interlace control information are read from the valid random reference data element. Each random data element with a length of 16 bits is interlaced into the address data element or address data associated therewith, wherein one bit of the secret 16 bits of the random data element to be interlaced is inserted into the bit data stream of the respective data element of the address data. Interlacing exactly occurs when the bit of the associated interlace control data element is ‘one’ or ‘zero’. Bit interlacing exactly terminates when all of the bits of the 16 bits of the random data element have been interlaced into the bit data stream of the respective data element of the address data, or when, at the end of the bit data stream, all bits of the secret 16 bits of the random data element that had not yet been interlaced, have been attached to the end of the bit data stream. SID card 1.4 determines, from the secret address data having a length of 96 bits, 128 bits of relative data with reference to card reference data. Furthermore, control data such as the position data element are adopted in the control information, from which, also, a relative data element with a length of at least 128 bits is determined. All of the relative data are arranged in a sequence, at least one hash value is generated therefrom, and this hash value is attached to the relative data. The data stream so formed is divided into partial data with a length of 1024 bits. From the partial data, relative data thereof, with a length of 1024 bits, are calculated with reference to associated card reference data. The relative data are subjected to another interlacing permutation and transmitted to unit 1.1. There, de-interlacing permutation is performed, and the 1024 bits of data are determined from the relative data thereof Unit 1.1 calculates all of the hash values and compares them with the hash values generated by the SID card. If they are identical, unit 1.1 determines the 96 bits of address data of the sender and at least the second position data element from the 128 bits of relative address data.

Unit 1.1 determines, using the position data, the separate random reference data element and the random data element with a length of 16 bits, or the random data with a length of 16 bits, and the interlace control data associated therewith. With these data, unit 1.1 generates the secret address data of the recipient with a length of 96 bits from the two address data (address data element, identity data element) of the recipient having a length of 80 bits each, and the respective random data element associated therewith. Unit 1.1 then determines the relative address data with a length of 128 bits. According to the invention, the relative address data with a length of 128 bits are calculated from the 128 bits of secret sender address gABAki with reference to a random reference data element PZki, from the 128 bits of secret recipient address gADAki with indirect reference to gABAki, from the 128 bits of secret sender identity gABIki with indirect reference to gADAki, and from the 128 bits of secret recipient identity gABIki with indirect reference to gADIki. The letter ‘k’ indicates the communication dependency, and the letter ‘i’ indicates the dependency from the i-th random reference data element valid in the current time interval. Random reference data element PZki is a random number generated in unit 1.1. The indirect reference is obtained by exclusive OR combining the respective data element with another random data element (which is also determined in unit 1.1). Unit 1.1 determines a first position data element. The position data element, like the second position data element, comprises two bytes. Both of the bytes have the same significance as with the byte position and bit position in the random reference data element mentioned above. The first position data element defines the bit position in the global random reference data element from where on a separate random reference data element is read. From the separate random data element, all of the separate random reference data necessary for P2P communication are extracted. Unit 1.1 determines P2P control information (including the first and second position data element), and calculates its relative data associated therewith with reference to P2P random reference data. Unit 1.1 arranges all of the relative data in a predefined sequence, calculates at least one hash value therefrom, adds it to the sequence of relative data, decomposes this data stream into 1024 bits of data each, calculates the 1024 bits of relative data therefrom, performs interlacing permutation, and transmits these data as a header in conjunction with other data to unit 2.1. The header and the other data generally are data according to any standard communication protocol.

Upon arrival at unit 2.1, the unit performs de-interlacing permutation, calculates the 1024 bits of data from the 1024 bits of relative data, determines all of the hash values, and compares the hash values calculated with the hash values received. In case a match occurs in all comparisons, unit 2.1 determines the 128 bits of address data gABAki, gADAki, gABIki, and gADIki from the 128 bits of relative data. Furthermore, it determines the position data. From the 128 bits of address data, the 96 bits of address data are determined, which then are retransformed into address data with a length of 128 bits with reference to card reference data. From the address data with a length of 128 bits referenced to the card reference data, the relative data thereof are determined with a length of 128 bits. The position data element SODki (SID position data element) is incorporated into a card control data element which is also transformed into relative card control information of a length of 128 bits. All of the relative data having a length of 128 bits are arranged in a predefined sequence. From this sequence, unit 2.1 calculates at least one hash value and attaches it to the data sequence. Unit 2.1 decomposes the data sequence into 1024 bits of data each, calculates the 1024 bits of relative data thereof with reference to the card reference data associated therewith, performs at least one interlacing permutation on the data, and transmits these data to SID card device 2.2. SID card device 2.2 transmits these data to the SID card 2.4 of the recipient. SID card 2.4 performs de-interlacing permutation, determines the 1024 bits of data from the 1024 bits of relative data, determines all of the hash values, and compares the determined hash values with the hash values received. In case a match occurs in all comparisons, SID card 2.4 determines, from the relative address data with a length of 128 bits, the address data with a length of 128 bits, from which it then determines the secret address data with a length of 96 bits. From the card control information, SID card 2.4 determines the position data element SODki. Using the position data element (second position data element), the card reads, from the random reference data element associated therewith, the random data element with a length of 16 bits, or the random reference data with a length of 16 bits, and the interlace control data associated therewith. Using the interlace control data, the address data having a length of 96 bits are decomposed into the address data with a length of 80 bits and the random data with a length of 16 bits. The de-interlaced address data element of the recipient is compared with the address data element which is authorized and unalterably stored in the SID card. The de-interlaced identity data element of the recipient is compared with the identity data element authorized and unalterably stored in the SID card. Also, all of the de-interlaced random data with a length of 16 bits are compared with the random data read from the random reference data element and having a length of 16 bits. In case of a match in all of the predefined comparisons, the recipient and the sender are authenticated. SID card 2.4 informs the unit 2.1 about the validity of the address data and the authenticity of the recipient and the sender. Then, reception continues.

FIGS. 3 and 4 illustrate an exemplary embodiment of the second part of the method according to the invention in which the authentication processes are performed using personal SID cards, and the authentification processes are performed using units authorized by SID cards. FIG. 3 illustrates the authentification process at the sender's side, and FIG. 4 illustrates the authentication process at the recipient's side. The second part of the authentification according to the invention by a unit authorized by an SID card is, in its substantial parts, identical to the authentification of the first part of the method according to the invention. Therefore, only the parts of authorization and the authorized method steps are described in detail.

The method steps shown in FIG. 3 can be described as follows:

Step #1b: Selecting the addresses from address register via PSES touchscreen;

Step #2: Acknowledging the public addresses via touch button;

Step #2B: Entry in data exchange table with reference to the data to be exchanged and/or time;

Step #3: Communication PSES1→SID card

Request to provide the sender's address (authorized address and identity);

Step #4: Generating the secret address data of the sender with a length of 96 bits from the two address data of the sender with a length of 80 bits and at least one random data element having a length of 16 bits in conjunction with the bit position data element SODki →interlacing the address data of 2×80 bits with the random feature of 16 bits into 2×96 bits of secret address data of the sender;

Step #5:

Preparation of communication:

determining the relative data of the sender's address with a length of 128 bits and the SID control information (including SODki) with reference to the card random reference data →generating relative data with a length of 1024 bits→interlacing permutation of the relative data

Communication SID card→PSES1

De-interlacing permutation→determining the data with a length of 1024 bits from the relative data thereof→therefrom the relative address data having a length of 128 bits→therefrom the address data of the sender having a length of 96 bits→de-interlacing the 96 bits of address data;

Step #5.1B: Entry of the 2×80 bits of sender address data and SODki into authorization table (transfer of authorization to the PSES);

Step #5.2B: Data exchange according to data exchange table;

Step #5.3B: Generating the secret address of the sender with a length of 96 bits from the two 80 bits of address data of the sender and the at least one 16 bit random data element in conjunction with the bit position data element SODki→interlacing the address data of 2×80 bits with the 16 bit random feature into 2×96 bits of secret address data of the sender;

Step #6: Generating the secret 96 bits of address data of the recipient from the two 80 bits of address data of the recipient and the at least one 16 bit random data element in conjunction with the bit position data element SODki→Interlacing the address data of 2×80 bits with the 16 bit random feature into 2×96 bits of secret address data of the recipient;

Step #7: Determining the 128 bits of relative address data for

secret sender address gABAki with reference to das random reference data element PZki
secret recipient address gADAki with indirect reference to gABAki
secret sender identity gABIki with indirect reference to gADAki
secret recipient identity gADIki with indirect reference to gABIki;

Step #8: Preparation of communication:

determining the P2P control information (including SODki) with reference to P2P random reference data→generating the 1024 bits of relative data with reference to P2P random reference data→interlacing permutation→transmission in the header having a length of N×1024 bits→
P2P communication (PSES1→PSES2)—at the sender side
The method steps shown in FIG. 4 can be described as follows:

Step #1: Requesting transfer of reception authorization via touch button;

Step #2: Acknowledgment via touch button;

Step #3: Communication PSES2→SID card

(request to transfer reception authorization);

Step #4: Generating the secret 96 bits of address data of the sender from the two address data of the sender having a length of 80 bits each, and the at least one 16 bit random data element in conjunction with the bit position data element SODki→Interlacing the address data of 2×80 bits with the 16 bit random feature into 2×96 bits of secret address data of the sender;

Step #5:

Preparation of communication:

determining the 128 bits of relative data of the sender address and SID control information (including SODki) with reference to card random reference data→generating 1024 bits of relative data→interlacing permutation of the relative data;

Communication SID card→PSES1

De-interlacing permutation→determining the 1024 bits of data from the relative data thereof→therefrom the 128 bits of relative address data→therefrom the 96 bits of address data of the sender→De-interlacing the 96 bits of address data;

Steps #6&7: Entry of the 2×80 bits of recipient address data into authorization table;

Step #8: P2P communication (PSES1→PSES2)—at the recipient side De-interlacing permutation→determining the 1024 bits of data from the relative data thereof with reference to P2P random reference data→therefrom the 128 bits of relative address data with reference to P2P random reference data→determining the secret address data gABAki, gADAki, gABIki, and gADIki→determining the 96 bits of secret address data of the sender and of the recipient;

Step #9: empty;

Step #10:

De-interlacing the secret 96 bits of address data of the recipient and sender from the 16 bits of random features in conjunction with SODki;

Step #11: Comparison of the received and the authorized and stored recipient address

data→no data match→error!

→data match→continue!

Step #12:

Comparison of the address random characteristics, comparison of the identity random characteristics;

Step #13: match in all comparisons→recipient and sender authenticated!

Step #14: empty;

Step #15: Permission for further data reception.

The sender selects the addresses of recipients, for example from an address register. This can be done at home PC 1.3 or via touchscreen 1.11 of unit 1.1. The selected recipient address data are accommodated in a data exchange table. The data to be sent are associated with the respective recipient address. Further, the calendar date and/or the time of transmission are defined by the sender. The sender has to acknowledge all of the data of the data exchange table by actuating a touch button (aware declaration of intention). The unit requests from SID card 1.4 to provide the sender's addresses. SID card 1.4 supplies the 96 bits of address data of the sender and the position data element SODki, according to the description of the method steps 3-5 of FIG. 2. From the 96 bits of address data, the authorized address data element with a length of 80 bits and the authorized identity data element of the SID card 1.4 with a length of 80 bits are determined by de-interlacing. Both sender address data with a length of 80 bits each, and the second position data element are added to an authorization table of unit 1.1, which authorization table has a relationship to the data exchange table. By actuating an authorization transfer button (aware declaration of intention) on touchscreen 1.11, a copy of the authorization for performing authentification is transmitted from SID card 1.4 to unit 1.1. At the recipient's side, the recipient requests transfer of a copy of the reception authorization from SID card 2.4 via a touch button of touchscreen 2.11 of unit 2.1. Acknowledgment of the request by the recipient via touch button is an aware declaration of intention of the recipient. SID card 2.4 transfers the 96 bits of address data and the position data element SODki, according to the method steps 3-5 of FIG. 2. Unit 2.1 determines, from the 96 bits of address data, the authorized address data element having a length of 80 bits and the authorized identity data element of SID card 2.4 having a length of 80 bits, and transfers the data into the authorization table of unit 2.1. Furthermore, the person transferring the authorization defines the data for automatic termination of the authentification authorization which are also stored in the authorization table of unit 2.1. By actuating the authorization transfer button, the copy of the authentification authorization of unit 2.1 is enabled. In this method part according to the invention the authorized unit performs steps 9 through 14. The unit may, at any time, be deprived from the authentification authorization by the person having passed the authorization. In order that the authorization passing person does not loose overview, each transfer of an authentification authorization is logged in the SID card of the person passing the authorization. This is carried out by storing at least the calendar date and/or time of transfer, and/or the identifying data element of the authorized unit, and/or the calendar date and/or time of deprivation of the authorization and/or automatic deletion of authorization.

1. A method for authentication and authentification of persons and units, wherein data exchange is performed between units by means of relative data and/or encrypted data, comprising:
performing the authentication and/or authentification of persons and/or units using personal units, or
performing the authentication and/or authentification of persons and/or units using units authorized for authentication and/or authentification, wherein a unit is authorized for authentication and/or authentification by having transferred to it at least one authorization copy from a personal unit by said personal unit after authentication of the possessor of said personal unit.

2. The method according to claim 1, wherein:
the authorization copy is at least one identifying data element of a person or a personal unit, or each are a identifying data element of a person or of a personal unit, and/or
the authentication and authentification of a person and/or a unit is performed in conjunction with a personal unit by means of data identifying the person and/or the unit, wherein authentication is performed with at least one data element via a worldwide unique characteristic which is inseparably combined with the person and/or the unit,
all of the data identifying the person are unalterably stored in the personal unit,
the data element identifying a unit is unalterably defined with the characteristic inseparably combined with the unit, or that the data identifying a unit are unalterably defined with the characteristics inseparably combined with the unit, and are unalterably stored in the unit,
the authenticity of a person and hence an attribution of the possessor of the personal unit is only verified in conjunction with the personal unit,
the identifying data used for verification have at least one secret random data element which is only defined in conjunction with the personal unit,
upon each new authentification, the identifying data element or the identifying data is or are provided with at least one new random data element in conjunction with the personal unit of the sender,
the transmission of the identifying data provided with at least one random data element only occurs in form of relative data,
the calculation of the relative data upon each new exchange is performed with at least one new random reference data element within dynamically changing spaces,
at least a part of the random reference data and/or spatial data are randomly generated by the transmitting unit,
the transmission of the random reference data and/or spatial data generated in the transmitting unit is performed with relative data,
the transmitting unit, by data interlacing and/or permutations, makes it impossible for a third party to associate the relative data in the transmitted data stream, wherein a data receiving unit extracts a part of the data interlace information from a part of the relative data and/or from a global random reference data element present in each unit and valid for a time interval,
the data receiving unit calculates the absolute data for all of the transferred relative data from the transferred relative data with reference to the random reference data within dynamically changing spaces,
the verification or verifications of the transferred identifying data is or are performed by the data receiving unit only in conjunction with the personal unit of the recipient, and
by verifying the validity and authenticity of the identifying data of the recipient by the data receiving unit and/or the personal unit of the recipient, the validity and authenticity of the identifying data of the sender is concurrently verified.

3. The method according to claim 2 wherein:
he identifying data used for authentication of a person are biometrical data, and/or the identifying data used for authentification of a person are address data comprising at least one address data element and identity data element and/or a personal identity number; and/or
the identifying data element used for authentification of a unit is a worldwide unique device number; and/or
at least one random reference data element is a random number and at least one other separate random reference data element is a part of at least one global random reference data element which is valid for all of the units and for a time interval, wherein the separate random reference data element is randomly extracted from the global random reference data element and the position of extraction is recorded in at least one first position data element; and/or
in function of a position data element from the global random reference data element, other data are read, for calculating spatial coordinates and/or as a data interlace information; and/or
the secret data interlace information intended for the identifying data is randomly extracted from the global random reference data element and/or from at least one random number generated in the transmitting unit, wherein the position of reading of the secret data interlace information is identified by at least one position data element, and
the position data are transmitted in at least one relative data element.

4. The method according to claim 2, wherein:
one secret random data element is interlaced into each identifying data element; and/or
one secret random data element is interlaced into each of two data of the address data of the sender and the recipient, or one secret random data element is interlaced into each of the address data of the sender and of the recipient, or that one secret random data element is interlaced into the address and identity data element of the sender and the recipient.

5. The method according to claim 4, wherein:
the data interlace information are data of a random number, and/or data of the global random reference data element, and/or data of a separate random reference data element extracted from the global random reference data element, and comprise at least the secret random data element to be interlaced and the interlace control data element,
one bit of the secret random data element to be interlaced is inserted into the bit data stream of the respective data element of the address data when the bit in the interlace control data element is one or zero, and
bit interlacing is terminated when all of the bits of the random data element have been interlaced into the bit data stream of the respective data element of the address data, or when all of the bits of the secret random data element that have not yet been interlaced until the end of the bit data stream have been attached to the end of the bit data stream.

6. The method according to claim 2, wherein, for the concurrent authenticity and validity verification of the address data of the sender and the recipient, the transmitting unit calculates at least one relative data element of the address data of the recipient with reference to at least one data element of the sender.

7. The method according to claim 6, wherein:
the interlaced sender address data element is referenced to at least one random reference data element, and the interlaced recipient address data element is referenced to at least one random data element related to the interlaced sender address data element, and the interlaced sender identity data element is referenced to at least one random data element related to the interlaced recipient address data element, and the interlaced recipient identity data element is referenced to at least one random data element related to the interlaced sender identity data element; and
the random data related to the interlaced address data element and/or to the interlaced identity data element are the results of coordinate related and bit-wise executed exclusive OR combining operations between the interlaced address data used as position vectors and the random number or random numbers used as position vector(s).

8. The method according to claim 3, wherein:
the personal unit predefines at least one position data element or all of the position data or at least the second position data element; and/or
the personal unit of the recipient performs authentification by comparing the transferred identifying data of the recipient with the authorized identifying data that are unalterably stored in the personal unit, and/or by comparing the de-interlaced random data, wherein if a match occurs as a result in all comparisons, the recipient and the sender are authenticated.

9. The method according to claim 2, wherein:
the authentication and/or authentification of a person and/or a unit is delegated to a unit, by a person in conjunction with the personal unit of said person;
said delegation comprises at least transferring a position data element and transferring a copy of authorization of the identifying data in the personal unit, to the unit intended to perform authentication and/or authentification henceforth;
the unit intended to perform authentication and/or authentification henceforth unalterably stores any position data related to the copy of authorization, and the identifying data transferred, and becomes a unit authorized for authentication and/or authentification, by a predefined action of the person who passes the copy of authorization; and
the unit authorized for authentification performs authentification by comparing the transferred identifying data of the recipient with the authorized identifying data that are unalterably stored in the authorized unit, and/or by comparing the de-interlaced random data, wherein if a match occurs as a result in all comparisons, the recipient and the sender are authenticated.

10. The method according to claim 1, wherein:
the data identifying a person are address data, and/or signature data, and/or data allocated to the person; that said identifying data are unalterably stored in the personal unit;
said identifying data are interlaced with at least one random data element in the personal unit,
the data interlace information are data of a random number, and/or data of a global random reference data element, and/or data of separate random reference data which are read from a global random reference data element that is provided in all units and is valid for a randomly predefined time interval;
the position of reading is predefined with reference to the second position data element,
the respective interlaced identifying data element is transmitted to the data receiving unit as a relative data element together with the other relative data,
the data receiving unit determines, from said relative data, the identifying data element or the identifying data and the position data element, determines the data interlace information by means of said position data element, de-interlaces the interlaced identifying data therewith, and compares the respective de-interlaced random data element with the allocated data element from the random number and/or the random reference data element; and
if a match occurs between all of the de-interlaced and allocated random data, the authenticity of the respective identifying data element is detected.

11. The method according to claim 10, wherein the data allocated to a person are at least one of a social insurance number, tax number, account number, card validity data, card number, commercial register number, association register number, cooperation register number, certification data element, and at least one data element of the certifying authority.

12. The method according to claim 2, wherein:
the data identifying a person are imported into a unit identifying said person during an instruction process, and are unalterably stored in said unit identifying the person, wherein the instruction process is performed by a person authorized for instruction; or
the data identifying a person and at least one certification date and/or card validity date are imported into a unit identifying said person during an instruction process, and are unalterably stored in said unit identifying the person, wherein the instruction process is performed by a person authorized for instruction.

13. The method according to claim 12, wherein:
in the instruction process, biometrical data and/or signature data are imported and stored as said data identifying a person,
the biometrical data and/or signature data are imported at least a second time, and are compared with the stored data,
upon a match thereof, the instruction process for the data identifying a person is terminated and the unit identifying a person is enabled, and is allocated to the person as a personal unit, and
by enabling the personal unit, the data identifying the person, and/or the data identifying the personal unit, and the certification data and card validity data are authenticated.

14. The method of claim 13, wherein:
in another instruction process, following successful authentication of the person possessing the personal unit, the personal data are imported into the personal unit by said personal unit, and are stored in said personal unit in a manner unalterably by a third party, and
a modification of the personal data can only be executed following successful authentication of the person possessing the personal unit.

15. The method according to claim 9, wherein:
the transfer of an authorization copy to an authorized unit is stored in an authorization table; and
the authorization table comprises at least the authorized data of the data identifying a person, and/or the authorized data of the personal unit, and/or the personal data, and/or a position data element, and/or the calendar date and/or the time of authorization, and/or the calendar date and/or the time of deletion of the authorization, and/or
the copy of authorization of the authorized unit can be deprived by the person having passed the authorization, after authentication of the person attributed to the authorization, and/or
each action related to the authorization has to be acknowledged by an action of the person attributed to said authorization, and/or
said authorization table is related to a data exchange table in the unit that is to transmit data, which table contains definitions about the data to be transmitted,
said definitions comprise the data to be transmitted, and/or the calendar date and the times of transmissions, and the identifying data of the recipient, and/or
the authorization table in the data receiving unit is related to a data reception table which contains definitions about the data to be received,
said definitions include the data to be received, and/or the calendar date of reception, and the data identifying the sender, and/or
each transfer of an authorization copy to a unit performing authentication and/or authentification is logged and stored in the personal unit of the person attributed to the authorization, and
the contents of the log comprise at least the calendar date and/or the time of the transfer of authorization, and/or the identifying data element of the authorized unit, and/or das calendar date and/or the time of deprivation of authorization or deletion of authorization.

16. The method according to claim 1 wherein the personal unit is a secure electronic card and serves as an identity card and/or service identity card and/or employee identity card and/or user identity card and/or health insurance card for the cyberspace.
